(19) United States
(12) Patent Application Publication
(10) Pub. No.: US 2026/0162383 A1
(43) Pub. Date: Jun. 11, 2026

(54) INFORMATION PROCESSING DEVICE AND CONTROL METHOD FOR INFORMATION PROCESSING DEVICE

(71) Applicant: CANON KABUSHIKI KAISHA, Tokyo (JP)

(72) Inventor: Katsunori TAI, Kanagawa (JP)

(21) Appl. No.: 19/394,986

(22) Filed: Nov. 20, 2025

(30) Foreign Application Priority Data
Dec. 11, 2024 (JP) 2024-216352

(51) Int. Cl. G06T 19/00; G06T 5/50

(52) U.S. Cl. CPC G06T 19/006; G06T 5/50; G06T 2207/20221

(57) ABSTRACT

An information processing device, connected to an imaging device, includes: a processor; and a memory storing a program which, when executed by the processor, causes the information processing device to: acquire a first image in which a space is imaged according to a viewpoint of a user; acquire a second image in which the space is imaged by the imaging device; and generate a composite image by combining a virtual object, the first image, and the second image, wherein when the user is not looking at a region of the second image, the virtual object is combined with a region of the first image, not with the region of the second image, and when the user is looking at the region of the second image, the virtual object is combined with the region of the second image, not with the region of the first image.

### BACKGROUND

### Field of the Technology

The present disclosure relates to an information processing device and a control method for the information processing device.

### Description of the Related Art

A virtual reality (VR) technology is known as a technology with which a virtual space can be experienced. In addition, a so-called mixed reality (MR) technology (technology of mixed reality feeling) is known as a technology for seamlessly fusing a real space and a virtual space in real time. As a device with which such a technology can be experienced, for example, a head-mounting type device represented by a head mounted display (HMD) is used.

In order to photograph a space (MR space) including a real space and a virtual object at an arbitrary angle of view, a screenshot function of an HMD equipped with an MR technology is used. In this case, in order to photograph a high-quality MR image, it is conceivable that the user photographs the MR space while confirming the photographing angle of view and the preview image from the viewpoint of the external imaging device using the external imaging device having high photographing performance. At this time, for example, the HMD performs self-position/orientation estimation processing and 3D object drawing processing on the basis of the photographed image received from the external imaging device, and generates a preview image by combining the virtual object image and the photographed image generated by the processing.

In Japanese Patent Laid-Open No. 2017-055397, a first imaging unit (such as a global shutter sensor typified by a CCD) is analyzed to estimate the position and orientation of the MR device. Then, a CG object is drawn on the video generated using the second imaging unit (rolling shutter sensor typified by CMOS, or the like) on the basis of the estimated position and orientation of the MR device. As a result, the processing cost is reduced. Further, in Japanese Patent National Publication of International Application No. 2022-551734, any of a plurality of types of devices accesses an environment map, estimates a position and an orientation of the device in relation to the environment map, and renders virtual content at a designated position. As a result, the processing cost is reduced.

Here, in order to enable the user to confirm the virtual object and the like from various viewpoints, the virtual object may be arranged in an image obtained by imaging the real space from each of the viewpoints of the HMD and the external imaging device. However, in an HMD or the like in which comfortable wearability and portability are required, it is difficult to secure processing capability for processing the self-position/orientation estimation processing and the 3D object drawing processing for each viewpoint of the HMD and the external imaging device. Therefore, it has been difficult for the user to grasp what kind of photographing is possible by viewing the MR image (image including the real space and the virtual object) displayed on the HMD.

### SUMMARY

The present disclosure is directed to a technology that enables a user to generate a high-quality image including a real space and a virtual object with a lower load, the high-quality image being an image for confirming what kind of photographing is possible.

One embodiment of the present disclosure is an information processing device communicably connected to an imaging device, the information processing device including: a processor; and a memory storing a program which, when executed by the processor, causes the information processing device to: execute first acquisition processing of acquiring a first image in which a space is imaged according to a viewpoint of a user; execute second acquisition processing of acquiring a second image in which the space is imaged by the imaging device; and execute control processing of generating a composite image obtained by combining a virtual object, the first image, and the second image, wherein in the control processing, in a first case where it is determined that the user is not looking at a region of the second image in the composite image, control is performed such that the virtual object is combined with a region of the first image in the composite image, and the virtual object is not combined with the region of the second image in the composite image, and in a second case where it is determined that the user is looking at the region of the second image in the composite image, control is performed such that the virtual object is combined with the region of the second image in the composite image, and the virtual object is not combined with the region of the first image in the composite image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for explaining a configuration of a system according to a first embodiment.

FIGS. 2A and 2B are external views of a camera according to the first embodiment.

FIG. 3 is an internal configuration diagram of the camera according to the first embodiment.

FIG. 4 is an internal configuration diagram of an HMD and the like according to the first embodiment.

FIG. 5 is a diagram illustrating an MR space according to the first embodiment.

FIGS. 6A to 6C are diagrams illustrating display examples of the HMD according to the first embodiment.

FIG. 7 is a flowchart of processing of the camera according to the first embodiment.

FIG. 8 is a flowchart of processing of a PC according to the first embodiment.

### DESCRIPTION OF THE EMBODIMENTS

Hereinafter, embodiments will be described in detail with reference to the accompanying drawings. Note that, the following embodiments do not limit the disclosure according to the claims. Although a plurality of features are described in the embodiment, not all of the plurality of features are essential, and the plurality of features may be freely combined. Furthermore, in the accompanying drawings, the same or similar configurations are denoted by the same reference numerals, and redundant description will be omitted.

### First Embodiment

### Configuration of Entire System

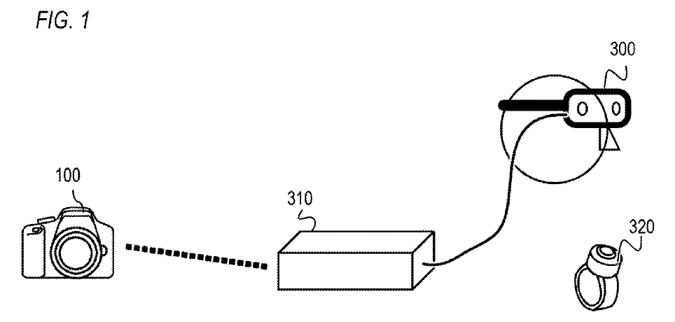

An example of a configuration of the entire system according to the first embodiment will be described with reference to FIG. 1. An information processing system 1 includes a camera 100, an HMD 300, a personal computer (PC) 310, and a controller 320.

The camera 100 is connected to the PC 310 in a wired or wireless communicable state. The camera 100 transmits and receives various data (live view image data, photographed image data, and the like). Note that, for example, instead of the camera 100, an imaging device (a smartphone, a tablet terminal, or the like) capable of realizing the functions described below may be used. Note that the camera 100 may communicate with not only the PC 310, but also the HMD 300.

The HMD 300 is a display device (head-mounting type electronic device) that can be mounted on the head of the user. The HMD 300 displays a composite image in which “a captured image obtained by imaging a range in front of the user by the HMD 300” and “content such as CG in a form corresponding to the position and orientation of the HMD 300” are combined.

The PC 310 is an information processing device that controls the HMD 300. The PC 310 is connected to the HMD 300 in a wired manner such as a USB cable or in a wireless manner such as Bluetooth (trademark) or Wireless Fidelity (Wi-Fi) (trademark). For example, the PC 310 generates a composite image by combining the captured image and the CG, and transmits the composite image to the HMD 300. In this case, when receiving the live view image or the photographed image from the camera 100, the PC 310 generates a composite image in which the received image and the CG in a form corresponding to the position and orientation of the camera 100 are combined. The PC 310 transmits the composite image to the HMD 300.

Note that a smartphone or a tablet terminal may be used instead of the PC 310. Furthermore, each configuration of the PC 310 may be included in the HMD 300. Note that, in the first embodiment, an example in which the PC 310 and the camera 100 are wirelessly connected is shown, but the PC 310 and the camera 100 may be connected by wire.

The controller 320 performs various controls of the HMD 300. In a case where the PC 310 is in a specific control mode, when a user operation is performed on the controller 320, the HMD 300 is controlled according to the user operation. As illustrated in FIG. 1, the controller 320 is an operation member having a “ring shape that can be worn on and supported by a user's finger” or a “hand-held shape held by a hand”. In addition, the controller 320 includes physical buttons for performing a determination operation and a selection operation displayed on the display.

The controller 320 performs wireless communication by Bluetooth with PC 310. Note that the controller 320 may communicate with not only the PC 310, but the HMD 300. The user can change the instruction position on the display according to the movement of the controller 320 by moving the controller 320. The instruction position may be expressed by a point, or the point of the instruction position and the controller may be connected by a straight line (line segment) or a dotted line and expressed by a virtual ray (ray). The user can perform a menu determination operation or a menu selection operation by pressing a physical button.

Note that the shape of the controller 320 is a ring type or a handheld type. However, the controller 320 may have any shape as long as it can be supported by a finger, a hand, or an arm. In addition, although the buttons of the controller 320 are physical buttons, it is sufficient that the buttons can be operated like a track pad, a touch panel, a wheel, or a track ball. Further, the controller 320 may be capable of receiving a slide operation, a flick operation, and a touch operation in addition to button pressing. Note that the controller 320 may be attachable to at least one of a finger, a hand, or an arm. Note that the controller 320 may be attached to an object held by hand, and position information and orientation information of the attached position may be acquired from the sensor. Examples of such an object include an object imitating a tool.

### External Configuration of Digital Camera

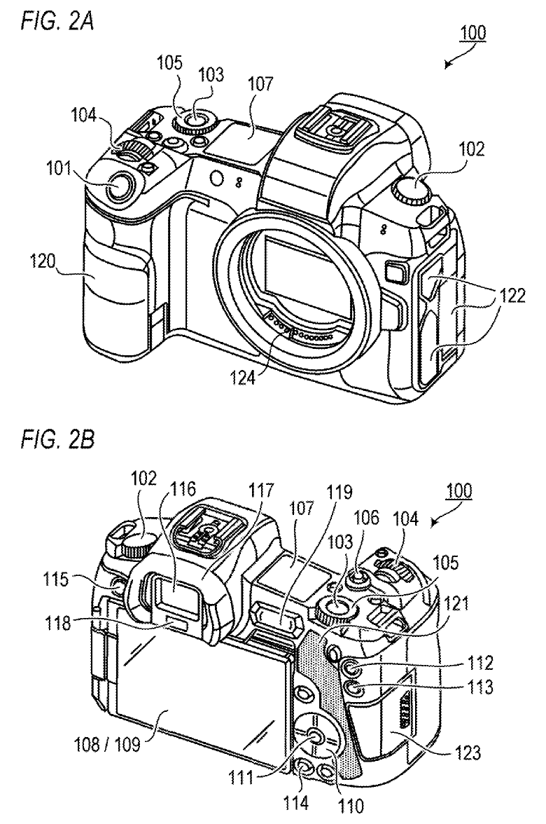

FIGS. 2A and 2B are diagrams illustrating an example of an external configuration of a camera 100 that is an imaging device. FIG. 2A is a perspective view of the camera 100 as viewed from the front. FIG. 2B is a perspective view of the camera 100 as viewed from the back.

The camera 100 includes, on an upper surface thereof, a shutter button 101, a power switch 102, a mode selector switch 103, a main electronic dial 104, a sub- electronic dial 105, a moving image button 106, and an outside viewfinder display unit 107.

The shutter button 101 is an operation unit for performing a photographing preparation or a photographing instruction. The power switch 102 is an operation unit for switching on or off of a power supply of the camera 100. The mode selector switch 103 is an operation unit for switching various modes.

The main electronic dial 104 is a rotary operation unit for changing setting values such as a shutter speed and an aperture value. The sub-electronic dial 105 is a rotary operation unit for moving a selection frame (cursor) and feeding images.

The moving image button 106 is an operation unit for providing an instruction to start or stop moving image photographing (recording). The outside viewfinder display unit 107 displays various setting values such as a shutter speed and an aperture value.

In addition, the camera 100 includes a display unit 108, a touch panel 109, a direction key 110, a SET button 111, an AE lock button 112, an enlargement button 113, a reproduction button 114, a menu button 115, an eyepiece part 116, an eyepiece detection unit 118, and a touch bar 119 on the back surface.

The display unit 108 displays images and various types of information. The touch panel 109 is an operation unit for detecting a touch operation on a display surface (touch operation surface) of the display unit 108.

The direction key 110 is an operation unit configured with keys that can be pressed up, down, left, and right (four direction keys). The camera 100 can be controlled according to the pressed position of the direction key 110. The SET button 111 is an operation unit to be pressed mainly when a selected item is determined.

The AE lock button 112 is an operation unit to be pressed when an exposed state is fixed in a photographing standby state.

The enlargement button 113 is an operation unit for switching on or off of an enlargement mode in live view display (LV display) of a photographing mode. In a case where the enlargement mode is on, when the main electronic dial 104 is operated, the live view image (LV image) is enlarged or reduced. The enlargement button 113 is used to enlarge the reproduced image or increase the enlargement ratio in the reproduction mode.

The reproduction button 114 is an operation unit for switching the photographing mode and the reproduction mode. In the photographing mode, when the reproduction button 114 is pressed, the mode shifts to the reproduction mode, and the latest image among the images recorded in the recording medium 227 described later is displayed on the display unit 108.

The menu button 115 is an operation unit to be pressed for displaying a menu screen, which enables various settings, on the display unit 108. A user can intuitively perform various settings by using the menu screen displayed on the display unit 108, the direction key 110, and the SET button 111.

The eyepiece part 116 is a part for bringing an eye closer to (in contact with) the eyepiece finder (looking-in type finder) 117. The user can visually recognize the video displayed on an electronic view finder (EVF) 217 through the eyepiece part 116.

The eyepiece detection unit 118 is a sensor that detects whether or not the user is in contact with the eyepiece part 116.

The touch bar 119 is a linear touch operation unit (line touch sensor) capable of receiving a touch operation. The touch bar 119 is disposed “at a position capable of a touch operation (touchable) with the thumb of the right hand in a state where a grip portion 120 is gripped with the right hand (a state gripped with the little finger, the ring finger, and the middle finger of the right hand)” such that the shutter button 101 can be pressed by the index finger of the right hand. That is, the touch bar 119 can be operated in a state in which an eye is brought into contact with the eyepiece part 116 to look into the eyepiece finder 117 and the camera is held so that the shutter button 101 can be pressed at any time (photographing posture). The touch bar 119 can receive a tapping operation on the touch bar 119 (an operation of touching and releasing the touch bar without moving within a predetermined period of time), a sliding operation to the left or right (an operation of touching the touch bar and then moving the touch position while keeping the touch), and the like. The touch bar 119 is an operation unit that is different from the touch panel 109 and does not have a display function. The touch bar 119 of the present embodiment is a multi-function bar and functions as, for example, an M-Fn bar.

In addition, the camera 100 has a grip portion 120, a thumb rest portion 121, a terminal cover 122, a lid 123, a communication terminal 124, and the like.

The grip portion 120 is a holding portion formed in a shape easy for the user to grip with the right hand when the user holds the camera 100. The shutter button 101 and the main electronic dial 104 are arranged at positions capable of operation with the index finger of the right hand in a state where the camera 100 is held with the grip portion 120 gripped with the little finger, the ring finger, and the middle finger of the right hand. In the same state, the sub-electronic dial 105 and the touch bar 119 are arranged at positions capable of being operated by the thumb of the right hand.

The thumb rest portion 121 (thumb standby position) is a grip portion provided on the back side of the camera 100 at a place where the thumb of the right hand gripping the grip portion 120 is easily placed in a state where no operation unit is operated. The thumb rest portion 121 is configured with a rubber member for enhancing holding power (gripping feeling).

The terminal cover 122 protects a connector such as a connection cable for connecting the camera 100 to an external device. The lid 123 closes a slot for storing the recording medium 227 to protect the recording medium 227 and the slot.

The communication terminal 124 is a terminal for communicating with a lens unit 200.

### Internal Configuration of Digital Camera

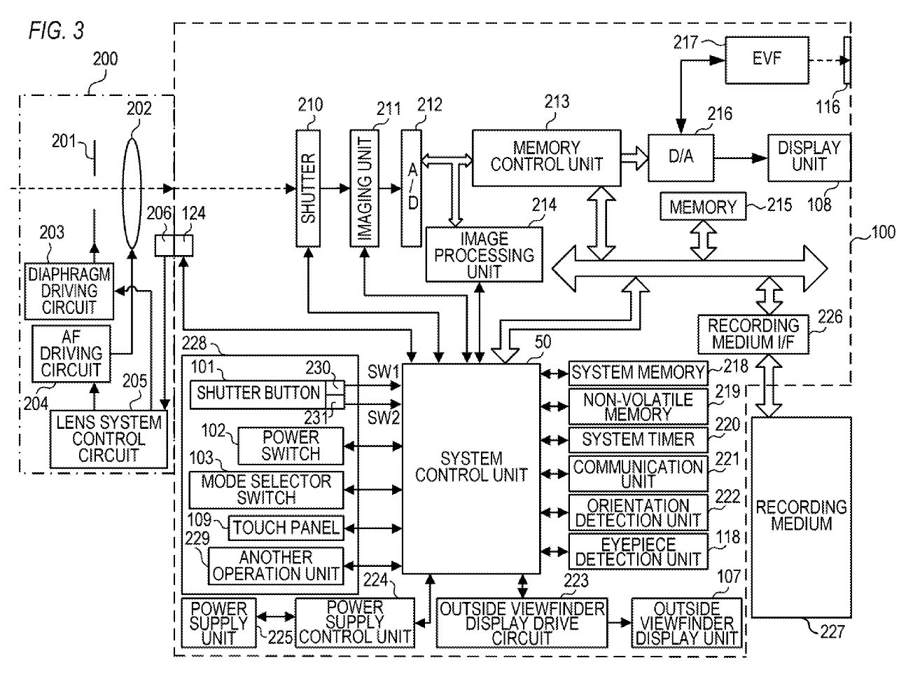

FIG. 3 is a view illustrating an example of an internal configuration of the camera 100. In FIG. 3, the same components as those in FIGS. 2A and 2B are denoted by the same reference numerals, and the description thereof will be appropriately omitted. The lens unit 200 is attached to the camera 100.

First, the lens unit 200 will be described. The lens unit 200 is a kind of interchangeable lens detachable from the camera 100. The lens unit 200 is a single lens, an example of a typical lens. The lens unit 200 includes a diaphragm 201, a lens 202, a diaphragm driving circuit 203, an autofocus (AF) driving circuit 204, a lens system control circuit 205, a communication terminal 206, and the like.

The opening diameter of the diaphragm 201 is adjustable. The lens 202 is configured with a plurality of lenses. The diaphragm driving circuit 203 adjusts a quantity of light by controlling the opening diameter of the diaphragm 201. The AF driving circuit 204 adjusts the focus by driving the lens 202.

The lens system control circuit 205 controls the diaphragm driving circuit 203, the AF driving circuit 204, and the like on the basis of an instruction from the system control unit 50. The lens system control circuit 205 controls the diaphragm 201 via the diaphragm driving circuit 203. Further, the lens system control circuit 205 adjusts the focus by changing the position of the lens 202 via the AF driving circuit 204. The lens system control circuit 205 can communicate with the camera 100. Specifically, communication is performed via the communication terminal 206 of the lens unit 200 and the communication terminal 124 of the camera 100. The communication terminal 206 is a terminal for the lens unit 200 to communicate with the camera 100 side.

Next, the camera 100 is described. The camera 100 includes a shutter 210, an imaging unit 211, an A/D converter 212, a memory control unit 213, an image processing unit 214, a memory 215, a D/A converter 216, the EVF 217, the display unit 108, and the system control unit 50.

The shutter 210 is a focal plane shutter that can freely control an exposure time of the imaging unit 211 based on an instruction of the system control unit 50.

The imaging unit 211 is an imaging element (image sensor) configured with a CCD, a CMOS element, or the like that converts an optical image into an electrical signal. The imaging unit 211 may include an imaging-surface phase-difference sensor for outputting defocus-amount information to the system control unit 50.

The A/D converter 212 converts an analog signal output from the imaging unit 211 into a digital signal.

The image processing unit 214 performs predetermined processing (pixel interpolation, resizing processing such as reduction, color conversion processing, and the like) on data from the A/D converter 212 or data from the memory control unit 213. In addition, the image processing unit 214 performs predetermined calculation processing using the photographed image data, and the system control unit 50 performs exposure control and distance measurement control on the basis of the obtained calculation result. By this processing, through-the-lens (TTL)-type AF processing, auto exposure (AE) processing, EF (flash pre-flash) processing, and the like are performed. Furthermore, the image processing unit 214 performs predetermined calculation processing using the photographed image data, and performs TTL automatic white balance (AWB) processing on the basis of the obtained calculation result. The image data from the A/D converter 212 is written into the memory 215 via the image processing unit 214 and the memory control unit 213. Alternatively, the image data from the A/D converter 212 is written into the memory 215 via the memory control unit 213 without the intervention of the image processing unit 214.

The memory 215 stores “Image data obtained by the imaging unit 211 and converted into digital data by the A/D converter 212” and “image data to be displayed on the display unit 108 or the EVF 217”. The memory 215 has a sufficient storage capacity to store a predetermined number of still images, a moving image for a predetermined time, and sound. The memory 215 also serves as a memory (video memory) for image display.

The D/A converter 216 converts data for image display stored in the memory 215 into an analog signal, and supplies the analog signal to the display unit 108 and the EVF217. Therefore, the image data for display written in the memory 215 is displayed on the display unit 108 and the EVF 217 via the D/A converter 216. The display unit 108 and the EVF 217 provide display in response to the analog signal from the D/A converter 216. The display unit 108 and the EVF 217 is, for example, a display such as an LCD or an organic EL. The digital signal A/D converted by the A/D converter 212 and accumulated in the memory 215 is converted into an analog signal by the D/A converter 216. By sequentially transferring the analog signal to the display unit 108 and the EVF 217, live view display of displaying an image representing a real-time space is performed.

The system control unit 50 is a control unit including at least one processor and/or at least one circuit. That is, the system control unit 50 may be a processor, a circuit, or a combination of a processor and a circuit. The system control unit 50 controls the entire camera 100. The system control unit 50 executes a program recorded in the non-volatile memory 219 to implement each processing of a flowchart to be described later. The system control unit 50 also performs display control by controlling the memory 215, the D/A converter 216, the display unit 108, the EVF 217, and the like.

In addition, the camera 100 includes a system memory 218, a non-volatile memory 219, a system timer 220, a communication unit 221, an orientation detection unit 222, and an eyepiece detection unit 118.

For example, a RAM is used as the system memory 218. In the system memory 218, a “constant and variable for operation of the system control unit 50”, a “program read from the non-volatile memory 219”, and the like are developed.

The non-volatile memory 219 is an electrically erasable and recordable memory. For example, an EEPROM is used as the non-volatile memory 219. In the non-volatile memory 219, constants, programs, and the like for operation of the system control unit 50 are recorded. The program here is a program for executing processing of a flowchart to be described later.

The system timer 220 is a clocking unit that measures a time used for various types of control and a time of a built-in clock. The communication unit 221 transmits and receives a video signal or an audio signal to and from an external device connected by wireless or by a wired cable.

The communication unit 221 can also be connected to a wireless local area network (LAN) and the Internet. Furthermore, the communication unit 221 can also communicate with an external device by Bluetooth (trademark) and Bluetooth Low Energy. The communication unit 221 can transmit an image (including a live image) photographed by the imaging unit 211 and an image recorded on the recording medium 227. Furthermore, the communication unit 221 can receive image data and other various types of information from an external device.

The orientation detection unit 222 detects the orientation of the camera 100 with respect to the gravity direction. “Whether the image photographed by the imaging unit 211 is an image photographed with the camera 100 held horizontally or vertically” can be determined based on the orientation detected by the orientation detection unit 222. The system control unit 50 can add orientation information corresponding to the orientation detected by the orientation detection unit 222 to the image file of the image photographed by the imaging unit 211, or rotate and record the image. For example, an acceleration sensor or a gyro sensor can be used for the orientation detection unit 222. It is also possible to detect the movement of the camera 100 (whether or not it is panning, tilting, lifting, stationary, or the like) by using the orientation detection unit 222.

The eyepiece detection unit 118 can detect approach of an object to the eyepiece part 116 of the “eyepiece finder 117 incorporating the EVF 217”. For example, an infrared proximity sensor can be used for the eyepiece detection unit 118. In a case where an object approaches the eyepiece part 116, infrared rays projected from the light projecting part of the eyepiece detection unit 118 are reflected by the object and received by the light receiving part of the infrared proximity sensor. The distance from the eyepiece part 116 to the object can be determined by the amount of received infrared light (= sensor value). In this manner, the eyepiece detection unit 118 performs the eyepiece detection of detecting the proximity distance of the object to the eyepiece part 116. The eyepiece detection unit 118 is an eyepiece detection sensor that detects approach (contact with eye) and separation (separation from eye) of an eye (object) to and from the eyepiece part 116 of the eyepiece finder 117. In a case where an object approaching within a predetermined distance with respect to the eyepiece part 116 from the non-eye contacting state (non-approaching state) is detected, it is detected that an eye is in contact. On the other hand, in a case where the object whose approach has been detected is separated from the eye contacting state (approaching state) by a predetermined distance or more, it is detected that the eye is separated. The threshold for detecting the eye contact and the threshold for detecting the eye separation may be different, for example, by providing hysteresis or the like. In addition, after the eye contact is detected, the eye contacting state is assumed until the eye separation is detected. After the eye separation is detected, the non-eye contacting state is assumed until the eye contact is detected.

The system control unit 50 switches between display (display state) and non-display (non-display state) of each of the display unit 108 and the EVF 217 in accordance with the state detected by the eyepiece detection unit 118. Specifically, at least in the photographing standby state and when the switching setting of the display destination is the automatic switching, the system control unit 50 turns on the display with the display destination as the display unit 108 during the non-eye contact, and hides the EVF 217. In addition, the system control unit 50 turns on the display with the EVF 217 as the display destination and hides the display unit 108 during the eye contact. Note that the eyepiece detection unit 118 is not limited to the infrared proximity sensor, and other sensors may be used as long as a state that can be regarded as the eye contact can be detected.

Furthermore, the camera 100 includes an outside viewfinder display unit 107, an outside viewfinder display drive circuit 223, a power supply control unit 224, a power supply unit 225, a recording medium I/F 226, an operation unit 228, and the like.

The outside viewfinder display unit 107 displays various setting values (shutter speed, aperture value, and the like) of the camera 100 via the outside viewfinder display drive circuit 223.

The power supply control unit 224 includes a battery detection circuit, a DC-DC converter, a switch circuit that switches a block to be energized, and the like. The power supply control unit 224 detects whether or not the battery is attached, the type of the battery, the remaining battery level, and the like. Furthermore, the power supply control unit 224 controls the DC-DC converter on the basis of the detection result and the instruction of the system control unit 50, and supplies a necessary voltage to each unit (including the recording medium 227) for a necessary period.

The power supply unit 225 is a primary battery (an alkaline battery, a lithium battery, or the like), a secondary battery (NiCd battery, NiMH battery, Li battery, or the like), an AC adapter, or the like.

The recording medium I/F 226 is an interface with the recording medium 227. The recording medium 227 is a memory card or the like for recording a photographed image. The recording medium 227 is configured with a semiconductor memory, a magnetic disk, or the like.

The recording medium 227 may be detachable from the camera 100 or may be built in the camera 100.

The operation unit 228 is an input unit that receives an operation from the user (user operation). The operation unit 228 is used to input various instructions to the system control unit 50. The operation unit 228 includes a shutter button 101, a power switch 102, a mode selector switch 103, a touch panel 109, another operation unit 229, and the like.

The another operation unit 229 includes a main electronic dial 104, a sub-electronic dial 105, a moving image button 106, a direction key 110, a SET button 111, an AE lock button 112, an enlargement button 113, a reproduction button 114, a menu button 115, a touch bar 119, and the like.

The shutter button 101 includes a first shutter switch 230 and a second shutter switch 231.

The first shutter switch 230 is turned on in the middle of the operation of the shutter button 101, that is, by so-called half-pressing (photographing preparation instruction), and generates a first shutter switch signal SW1. Upon generation of the first shutter switch signal SW1, the system control unit 50 starts photographing preparation processing (AF processing, AE processing, AWB processing, EF processing, and the like).

The second shutter switch 231 is turned on at the completion of the operation of the shutter button 101 that is, by so-called full-pressing (photographing instruction) and generates a second shutter switch signal SW2. The system control unit 50 starts a series of photographing processing (from reading of a signal from the imaging unit 211 to generation and writing of an image file including a photographed image onto the recording medium 227) by generation of the second shutter switch signal SW2.

The mode selector switch 103 switches the operation mode of the system control unit 50 to any one of a still image photographing mode, a moving image photographing mode, a reproduction mode, and the like. The mode included in the still image photographing mode includes an automatic photographing mode, an automatic scene determination mode, a manual mode, an aperture priority mode (Av mode), a shutter speed priority mode (Tv mode), a program AE mode (P mode), and the like. The mode included in the still image photographing mode includes various scenes mode, a custom mode, and the like that are photographing settings for each photographing scene. The user can directly switch the mode to any of the above-described photographing modes with the mode selector switch 103. Alternatively, the user can temporarily switch a screen to a list screen of the photographing modes with the mode selector switch 103 and then selectively switch the mode to any of the plurality of displayed modes using the operation unit 228. Similarly, the moving image photographing mode may include a plurality of modes.

The touch panel 109 is a touch sensor that detects various touch operations on a display surface of the display unit 108 (an operation surface of the touch panel 109). The touch panel 109 and the display unit 108 can be integrally configured. For example, the touch panel 109 is attached to an upper layer of the display surface of the display unit 108 such that a transmittance of light of the touch panel 109 does not hinder the display on the display unit 108. Furthermore, input coordinates on the touch panel 109 and display coordinates on the display surface of the display unit 108 are associated with each other, thereby configuring a graphical user interface (GUI) such that the user can directly operate a screen displayed on the display unit 108. For the touch panel 109, any of various methods such as a resistive film method, a capacitance method, a surface acoustic wave method, an infrared method, an electromagnetic induction method, an image recognition method, and an optical sensor method can be used. Depending on the methods, there are a method of detecting a touch based on contact with the touch panel 109 and a method of detecting a touch based on approach of a finger or a pen to the touch panel 109, but any method may be adopted.

The system control unit 50 can detect the following operations or states on the touch panel 109.

An operation in which a finger or a pen that has not touched the touch panel 109 newly touches the touch panel 109, that is, a start of the touch (hereinafter, referred to as Touch-Down).

A state in which the finger or the pen is in contact with the touch panel 109 (hereinafter referred to as Touch-On).

An operation in which the finger or the pen is moving while being in contact with the touch panel 109 (hereinafter referred to as Touch-Move).

An operation in which the finger or the pen that is in contact with the touch panel 109 is separated from (released from) the touch panel 109, that is, an end of the touch (hereinafter referred to as Touch-Up).

A state in which nothing is in contact with the touch panel 109 (hereinafter referred to as Touch-Off).

When Touch-Down is detected, Touch-On is detected at the same time. After Touch-Down, normally Touch-On is continuously detected unless Touch-Up is detected. Also, when Touch-Move is detected, Touch-On is detected at the same time. Even when Touch-On is detected, Touch-Move is not detected unless the touch position is moved. After Touch-Up of all the fingers and the pens that have touched the touch panel 109 is detected, the state transitions to Touch-Off.

These operations and states and the position coordinates of the finger or the pen that is in contact with the touch panel 109 are notified to the system control unit 50 through an internal bus. The system control unit 50 determines what kind of operation (touch operation) has been performed on the touch panel 109 on the basis of the notified information. With regard to Touch-Move, also a movement direction of the finger or the pen moving on the touch panel 109 can be determined for each of a vertical component and a horizontal component on the touch panel 109, based on change of the position coordinates. When Touch-Move for a predetermined distance or longer is detected, it is determined that a sliding operation is performed. An operation of quickly moving a finger by a certain distance while touching the touch panel 109 and releasing the finger is called flick. In other words, the flick is an operation in which the finger is quickly slid on the touch panel 109 so as to flick the touch panel 109. When it is detected that Touch-Move is performed at a predetermined speed or more for a predetermined distance or more and Touch-Up is detected as it is, it is determined that flicking has been performed (it can be determined that flicking has occurred following the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinching operation (or simply referred to as a pinch).

### Configuration of HMD

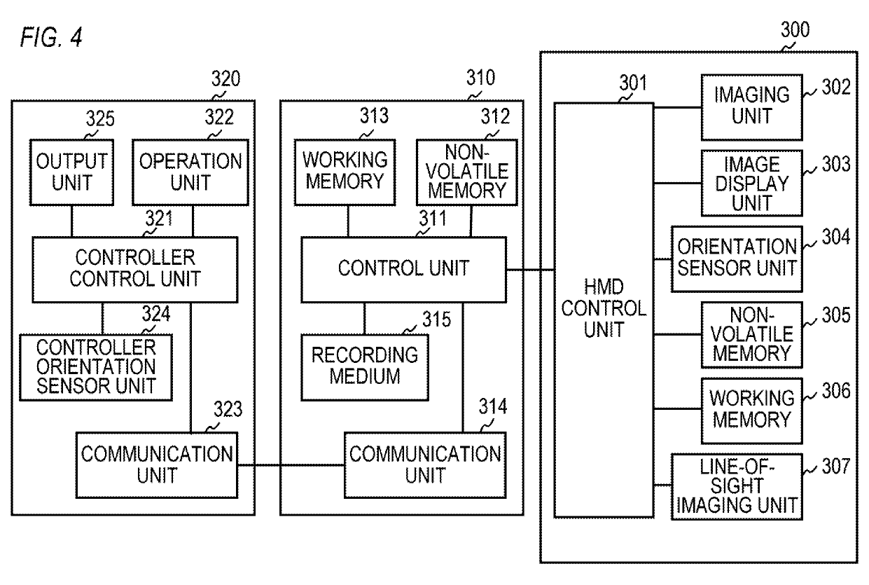

An example of a configuration of the HMD 300 will be described with reference to FIG. 4. The HMD 300 includes an HMD control unit 301, an imaging unit 302, an image display unit 303, an orientation sensor unit 304, a non-volatile memory 305, a working memory 306, and a line-of-sight imaging unit 307.

The HMD control unit 301 is a CPU that controls each component of the HMD 300. When acquiring a composite image (an image obtained by combining a captured image obtained by imaging the space in front of the user by the imaging unit 302 and the CG) from the PC 310, the HMD control unit 301 displays the composite image on the image display unit 303. Note that instead of the HMD control unit 301 controlling the entire device, a plurality of pieces of hardware may share processing to control the entire device.

The imaging unit 302 includes two cameras (imaging devices). The two cameras are for capturing a captured image used for combining with an image of a virtual space and generating position and orientation information, and include an imaging unit for the left eye and an imaging unit for the right eye. The imaging unit for the left eye captures a moving image of a real space corresponding to the left eye of the wearer of the HMD 300, and an image (captured image) of each frame in the moving image is output from the imaging unit for the left eye. The imaging unit for the right eye captures a moving image of a real space corresponding to the right eye of the wearer of the HMD 300, and an image (captured image) of each frame in the moving image is output from the imaging unit for the right eye. That is, the imaging unit 302 acquires a captured image as a stereo image having parallax substantially matched with the positions of the left eye and the right eye of the wearer of the HMD 300. Furthermore, information on the distance from the two cameras to an object can be acquired as distance information by distance measurement using the stereo camera. Note that, in the HMD for the MR system, it is preferable that the central optical axis of the imaging range of the imaging unit is arranged to substantially coincide with the line-of-sight direction of the wearer of the HMD.

Each of the imaging unit for the left eye and the imaging unit for the right eye includes an optical system and an imaging device. The light incident from the outside enters the imaging device through the optical system, and the imaging device outputs an image corresponding to the incident light as a captured image. Images of an object (a range in front of the user) captured by the two cameras are output to the PC 310 and the HMD control unit 301. Note that the imaging unit 302 may output a video instead of the captured image.

The image display unit 303 displays the composite image. The image display unit 303 includes a liquid crystal panel, an organic EL panel, or the like. In a state where the user wears the HMD 300, the image display unit 303 is arranged in front of each eye of the user. Note that a device using a semi-transmissive half mirror can also be used for the image display unit 303. In this case, for example, the image display unit 303 may display an image such that the CG is seen to be directly superimposed on the real space seen through the half mirror by a technique generally called augmented reality (AR). Furthermore, the image display unit 303 may display an image of a complete virtual space without using a captured image by a technology generally called virtual reality (VR).

The orientation sensor unit 304 acquires orientation (and position) information of the HMD 300. Note that the orientation sensor unit 304 may acquire orientation information of the user (the user wearing the HMD 300) corresponding to the orientation (and position) of the HMD300. For example, the orientation sensor unit 304 includes an inertial measurement unit (IMU) configured with an acceleration sensor, an angular acceleration sensor, and a geomagnetic sensor. The orientation sensor unit 304 is used to acquire information (orientation information) on the orientation of the user, and the HMD control unit 301 outputs the information (orientation information) on the orientation of the user to the PC 310. Note that the orientation information may be acquired from any one or more of a magnetic sensor (including a geomagnetic sensor), an ultrasonic sensor, an acceleration sensor, and an angular velocity sensor.

The HMD control unit 301 estimates the position or orientation of each joint point of the hand and the finger of the user on the basis of the images obtained by the two cameras of the imaging unit 302. Note that the joint points include points that are characteristic of parts such as a joint of a finger, a fingertip, a back of a hand (palm), and an arm. Each joint point indicates a coordinate position. The orientation of the hand can be estimated on the basis of the information of the plurality of joint points. As a method of estimating the positions or orientations of the hand and each joint point of the hand, for example, a known method of object recognition or pose estimation of machine learning using a convolutional neural network can be used. Furthermore, the position information in the depth direction of each joint point of the hand can be obtained, for example, by calculating the distance from the imaging unit 302 to each joint point by triangulation by stereo matching using images obtained by two cameras of the imaging unit 302. The estimated coordinate information of each joint point of the hand is output from the HMD control unit 301 to the PC 310.

The non-volatile memory 305 is an electrically erasable/recordable non-volatile memory, and stores a program or the like to be described later executed by the control unit 311.

The working memory 306 is used as a buffer memory that temporarily holds image data captured by the imaging unit 302, an image display memory of the image display unit 303, a work region of the HMD control unit 301, and the like.

The line-of-sight imaging unit 307 is a camera that acquires an image for detecting the line of sight of the user. The line-of-sight imaging unit 307 is attached inside the HMD 300 in order to image the user's eye when the user wears the HMD 300. An image obtained by photographing the object (user's eye) by the camera is output to the control unit 311 of the PC 310 via the HMD control unit 301. The control unit 311 detects the line of sight of the user wearing the HMD 300 from the image captured by the line-of-sight imaging unit 307, and specifies a portion gazed by the user on the image display unit 303.

### Internal Configuration of PC

An internal configuration of PC 310 will be described with reference to FIG. 4. The PC 310 includes a control unit 311, a non-volatile memory 312, a working memory 313, a communication unit 314, and a recording medium 315.

The control unit 311 is a CPU that controls each unit of the PC 310 according to an input signal or a program to be described later. Instead of the control unit 311 controlling the entire PC 310, a plurality of pieces of hardware may share processing to control the entire PC 310. The control unit 311 receives the image (captured image) acquired by the imaging unit 302 and the orientation information acquired by the orientation sensor unit 304 from the HMD 300. The control unit 311 performs image processing of canceling aberrations in the optical system of the imaging unit 302 and the optical system of the image display unit 303 on the captured image. Then, the control unit 311 combines the captured image and an arbitrary CG to generate a composite image. The control unit 311 transmits the composite image to the HMD control unit 301 in the HMD 300.

The control unit 311 also obtains the number of controllers 320 included in the captured image. In addition, the control unit 311 executes processing for recognizing the attached position of each controller 320 using the information obtained via the communication unit 314. Then, the control unit 311 performs control to change the operation content for the input information of each controller 320 for each controller according to the recognition result.

Note that the control unit 311 controls the position, orientation, and size of the CG in the composite image on the basis of the information (distance information and orientation information) acquired by the HMD 300. For example, in a case where the virtual object indicated by the CG is arranged near a specific object existing in the real space in the space indicated by the composite image, the control unit 311 increases the virtual object (CG) as the distance between the specific object and the imaging unit 302 is shorter. As described above, by controlling the position, orientation, and size of the CG, the control unit 311 can generate a composite image as if a CG object not arranged in the real space is arranged in the real space.

Furthermore, the control unit 311 receives information estimated by the HMD control unit 301 of the HMD 300. The received information is temporarily stored in the working memory 313.

Furthermore, the control unit 311 receives change information of the position or orientation of the controller 320 from the communication unit 323 of the controller 320. The control unit 311 superimposes a display item indicating an instruction position according to the change information of the position or orientation of the controller 320 on the combined image. Note that the control unit 311 may superimpose a display item indicating an instruction position according to the change information of the position and orientation of the controller 320 on the combined image.

The non-volatile memory 312 is an electrically erasable and recordable non-volatile memory. The non-volatile memory 312 stores a program to be described later executed by the control unit 311 and information such as CG. Note that the control unit 311 can switch computer graphics (that is, the CG used for generating the composite image) read from the non-volatile memory 312.

The working memory 313 is used as a buffer memory that temporarily holds image data imaged by the imaging unit 302 and estimated time series information of the coordinate position of each joint point of the hand. The working memory 313 is used as an image display memory of the image display unit 303, a work region of the control unit 311, and the like.

In addition, the hand joint may be estimated by the PC 310. In this case, after the captured image is output from the imaging unit 302 to the PC 310, the control unit 311 of the PC 310 estimates the position or orientation of each joint point of the hand. Then, the control unit 311 uses the information to process the image and outputs the processed image to the HMD 300. Note that the control unit 311 may estimate the position and orientation of each joint point of the hand, process the image using the information, and output the processed image to the HMD 300.

### Internal Configuration of Controller

An internal configuration of the controller 320 will be described with reference to FIG. 4. The controller 320 includes a controller control unit 321, an operation unit 322, a communication unit 323, a controller orientation sensor unit 324, and an output unit 325.

The controller control unit 321 is a CPU that controls each component of the controller 320. Note that instead of the controller control unit 321 controlling the entire controller 320, a plurality of pieces of hardware may share processing to control the entire controller 320.

The operation unit 322 includes a button. The operation unit 322 detects whether or not the button has been operated, and transmits detection information to the PC 310 via the communication unit 323. Note that the operation unit 322 may have a plurality of types of input formats.

The communication unit 323 performs wireless communication by Bluetooth with the PC 310. When the plurality of controllers 320 are connected to the PC 310, the communication unit 323 of each of the plurality of controllers 320 performs wireless communication by Bluetooth with the PC 310.

The controller orientation sensor unit 324 has an inertial measurement unit (IMU) including an acceleration sensor, an angular acceleration sensor, and a geomagnetic sensor. The inertial measurement unit detects a change in position or orientation of the controller 320. The detected change information in the position and orientation is communicated from the communication unit 323 to the PC 310 via the controller control unit 321.

The output unit 325 includes a light source of an LED, a speaker, a vibration element, and the like.

### Example of MR Space

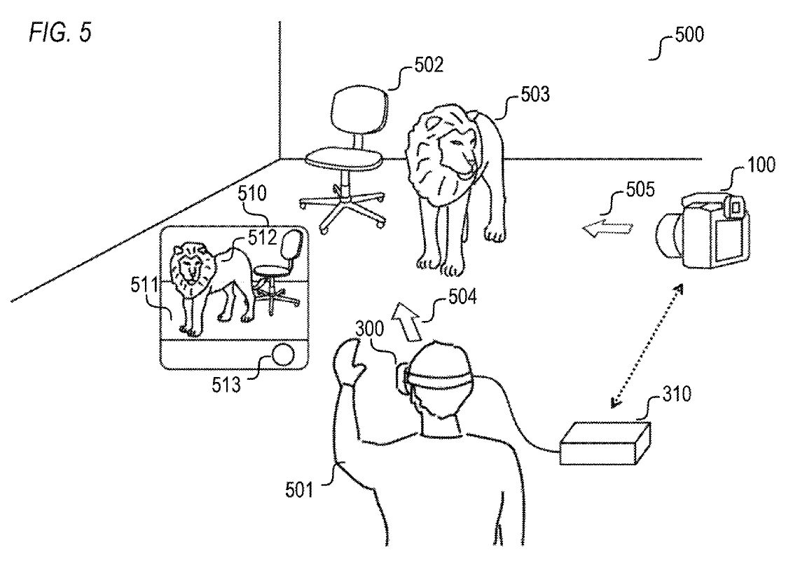

An example of an MR space experienced by the user wearing the HMD 300 in the first embodiment will be described with reference to FIG. 5. In the MR space 500, there are a user 501, an HMD 300 worn by the user 501, a PC 310 communicating with the HMD 300, and a camera 100 communicating with the PC 310. In addition, there are a real object 502, a virtual object 503, and a virtual window 510 in the MR space 500.

The virtual window 510 is an example of a UI of a photographing application. In the virtual window 510, a live view image 511, a virtual object 512, and an operation member 513 are displayed. The live view image 511 is an image acquired by imaging by the imaging unit 211 of the camera 100. The virtual object 512 is a virtual object in a form corresponding to the position and orientation of the camera 100.

Furthermore, an arrow 504 indicates a direction in which the imaging unit 302 of the HMD 300 worn by the user 501 captures an image. An arrow 505 indicates a direction in which the imaging unit 211 of the camera 100 captures an image.

### Display Example of HMD 300

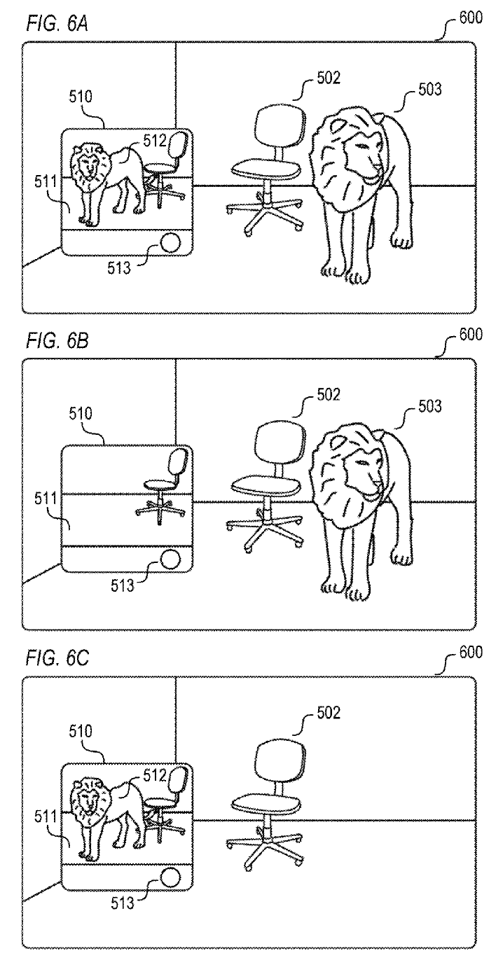

An example of display on the image display unit 303 of the HMD 300 according to the first embodiment will be described with reference to FIGS. 6A to 6C.

A screen 600 illustrated in FIG. 6A illustrates an example of display on the image display unit 303 of the HMD 300 in a case where the imaging unit 302 of the HMD 300 worn by the user 501 images the MR space in the direction of the arrow 504 in FIG. 5. A real object 502, a virtual object 503, and a virtual window 510 are displayed on the screen 600.

In the virtual window 510, a live view image 511, a virtual object 512, and an operation member 513 are displayed. The live view image 511 is an image acquired by imaging by the imaging unit 211 of the camera 100. The virtual object 512 is a virtual object in a form corresponding to the position and orientation of the camera 100.

Note that the position and orientation of the virtual object 503 and the virtual window 510 are adjusted to a position and orientation (position and orientation corresponding to the viewpoint of the user 501) corresponding to a case where the imaging unit 302 of the HMD 300 worn by the user 501 captures an image in the direction of the arrow 504 in FIG. 5. The position and orientation of the virtual object 512 displayed in the virtual window 510 are adjusted to a position and orientation (a position and orientation corresponding to the viewpoint of the camera 100) corresponding to a case where the imaging unit 211 of the camera 100 captures an image in the direction of the arrow 505 in FIG. 5.

Note that, in the first embodiment, a case where the user 501 in FIG. 5 can perform an operation of transmitting a photographing command to the camera 100 on the operation member 513 will be described, but the present disclosure is not limited thereto. For example, a plurality of operation members may be arranged in the virtual window 510, and an operation of transmitting a setting command of various photographing conditions and the like in addition to a photographing command can be assigned to each operation member. Furthermore, in the first embodiment, as illustrated in the MR space 500 of FIG. 5, a case where the virtual window 510 is arranged at an arbitrary three-dimensional position in the space as if virtually existing in an arbitrary three-dimensional orientation will be described, but the present disclosure is not limited thereto. The virtual window 510 may be arranged at any two-dimensional position in the display region of the screen 600.

A screen 600 illustrated in FIG. 6B illustrates an example of display on the image display unit 303 of the HMD 300 in a case where the user 501 illustrated in FIG. 5 does not pay attention to the virtual window 510. The virtual object 503 in a form based on the position and orientation of the HMD 300 is displayed, but the virtual object 512 in a form based on the position and orientation (position and orientation of the head of the user) of the camera 100 is not displayed.

A screen 600 illustrated in FIG. 6C illustrates an example of display on the image display unit 303 of the HMD 300 in a case where the user 501 in FIG. 5 pays attention to the virtual window 510. The virtual object 503 in a form based on the position and orientation of the HMD 300 is not displayed, but the virtual object 512 in a form based on the position and orientation of the camera 100 is displayed.

### Processing related to Live View Image in Camera 100

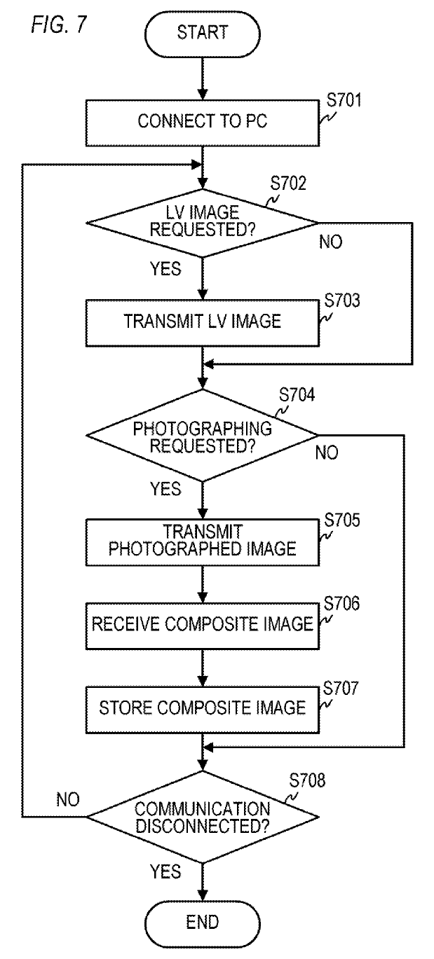

Processing using a live view image in the camera 100 according to the first embodiment will be described with reference to a flowchart in FIG. 7.

In step S701, the system control unit 50 controls the communication unit 221 to connect the camera and the PC 310 so as to enable communication. The connection with the PC 310 can be made by any connection method. The connection with the PC 310 may be realized by either wireless communication or wired communication.

In step S702, the system control unit 50 determines whether or not acquisition of a live view image (LV image) has been requested from the PC 310. In a case where it is determined that acquisition of a live view image has been requested, the process proceeds to step S703. In a case where it is determined that acquisition of a live view image has not been requested, the process proceeds to step S704.

In step S703, the system control unit 50 transmits the live view image (live view information) to the PC 310 so as to reply to the request for acquiring the live view image. Note that the system control unit 50 transmits lens optical information (optical characteristic information including lens aberration information) in addition to the live view image.

In step S704, the system control unit 50 determines whether or not photographing has been requested (photographing from the PC 310 has been requested, or photographing has been requested by the user operating the camera 100). In a case where it is determined that photographing has been requested, the process proceeds to step S705. In a case where it is determined that photographing has not been requested, the process proceeds to step S708.

In step S705, the system control unit 50 executes photographing processing. The system control unit 50 transmits an image (photographed image) acquired by photographing to the PC 310.

In step S706, the system control unit 50 receives the composite image from the PC 310.

In step S707, the system control unit 50 stores the composite image received in step 706 in the recording medium 227.

In step S708, the system control unit 50 determines whether or not the communication with the PC 310 is disconnected. In a case where it is determined that the communication with the PC 310 is disconnected, the processing of this flowchart ends. In a case where it is determined that the communication with the PC 310 is not disconnected, the process proceeds to step S702.

### Processing Flow Example in PC 310

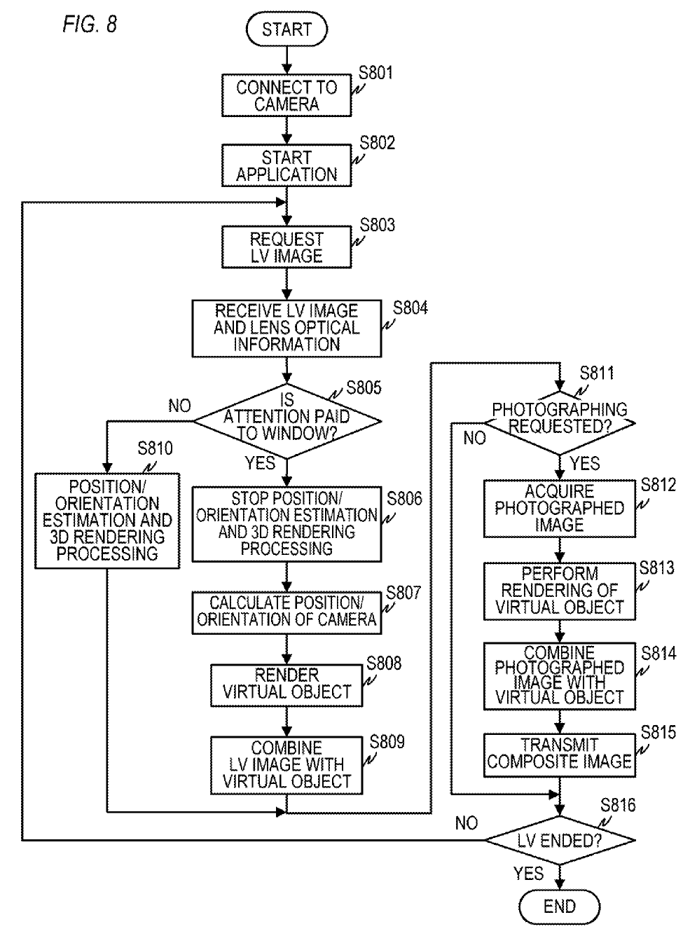

With reference to the flowchart in FIG. 8, processing in the PC 310 in the first embodiment will be described. Note that the HMD 300 (HMD control unit 301) may execute all or a part of the processing of this flowchart instead of the PC 310.

In step S801, the control unit 311 controls the communication unit 314 to connect the camera 100 and the PC 310 so as to enable communication. The type of connection method with the camera 100 is not limited. The connection with the camera 100 may be realized by either wireless communication or wired communication.

In step S802, the control unit 311 starts an application for realizing live view display. The window of the started application is displayed on the image display unit 303 as illustrated in a virtual window 510 on the screen 600 illustrated in FIG. 6A.

In step S803, the control unit 311 requests the camera 100 to acquire a live view image.

In step S804, the control unit 311 receives the live view image and the lens optical information from the camera 100.

In step S805, the control unit 311 determines whether or not the user 501 in FIG. 5 pays attention to the virtual window 510 (= region where the live view image is displayed) (gazes at the virtual window 510). In a case where it is determined that the user 501 pays attention to the virtual window 510, the process proceeds to step S806. In a case where it is determined that the user 501 does not pay attention to the virtual window 510, the process proceeds to step S810.

For example, in a case where it is determined that the predetermined region including the region of the virtual window 510 is located on the extension of the line-of-sight direction of the user 501, the control unit 311 determines that the user 501 pays attention to the virtual window 510 (gazes at the virtual window 510). In a case where it is determined that the ratio (occupancy rate) of the occupancy area of the display region of the virtual window 510 in the screen 600 (the entire LV composite image to be described later) exceeds a predetermined threshold, the control unit 311 may determine that the user 501 pays attention to the virtual window 510. Furthermore, in a case where it is determined that the user 501 is operating the operation member 513 (operation member corresponding to the virtual window 510) arranged in the virtual window 510, the control unit 311 may determine that the user 501 pays attention to the virtual window 510.

In step S806, the control unit 311 performs control to stop the “estimation processing of the position and orientation of the virtual object 503 based on the viewpoint of the HMD 300 and display processing of the virtual object 503 on the screen 600 (3D rendering processing and CG drawing processing)”. At this time, the control unit 311 may stop only the display processing of the virtual object 503. Note that details of this processing will be described later in the description of step S810.

In step S807, the control unit 311 calculates the position and orientation of the camera 100 on the basis of the live view image and the lens optical information. Note that, in the present embodiment, a method based on continuous image information such as simultaneous localization and mapping (SLAM) may be used to calculate the position and orientation. According to this, even if the camera 100 has only a general imaging function, the position and orientation of the camera 100 can be calculated. On the other hand, in a case where the camera 100 includes a mechanism capable of acquiring depth information such as a time of flight (ToF) sensor, the position and orientation may be calculated on the basis of the information.

In step S808, the control unit 311 performs 3D rendering processing on the basis of the position and orientation of the camera 100 calculated in step S807. Here, the control unit 311 generates an image of the virtual object 512. Note that the control unit 311 can generate a more natural image of the virtual object reflecting the imaging characteristics of the camera 100 by performing 3D rendering in consideration of the lens optical information received from the camera 100 in step S804.

In step S809, the control unit 311 arranges, in the virtual window 510, an image obtained by combining the live view image 511 and the image of the virtual object 512 generated in step S808. Then, the control unit 311 generates the LV composite image (see FIG. 6C) by combining the virtual window 510 and the image obtained by imaging the real space by the HMD 300. In the generated LV composite image, the virtual object 512 is arranged in the live view image 511, but the virtual object 503 is not arranged in an image obtained by imaging the real space by the HMD 300 (an image obtained by imaging the real space so as to correspond to the viewpoint of the HMD 300).

Note that the LV composite image is an image for the user 501 to confirm in real time at what angle of view the MR image in which the real space and the virtual object are combined is photographed by the camera 100. Therefore, the processing in steps S808 to S809 may have a lower load than the virtual object composite processing in steps S813 to S814 described later. For example, in the processing of steps S808 to S809, “reduction in quality (number of polygons, texture quality, etc.) of 3D model to be rendered”, “simplification of the shadow/shade effect and the reflection effect applied to the 3D model”, or the like may be performed.

In step S810, the control unit 311 executes processing (estimation processing) of estimating the position and orientation of the virtual object 503 on the basis of the viewpoint of the HMD 300 (user). Furthermore, the control unit 311 performs control to perform display processing (3D rendering processing and CG drawing processing) of the virtual object 503. As a result, the LV composite image including the virtual window 510 and the virtual object 503 as in the screen 600 illustrated in FIG. 6B is generated. In the generated LV composite image, the virtual object 512 is not arranged in the live view image 511, but the virtual object 503 is arranged in an image obtained by imaging the real space by the HMD 300 (an image obtained by imaging the real space so as to correspond to the viewpoint of the HMD 300).

In step S811, the control unit 311 determines whether or not photographing has been requested. The case where photographing is requested is a case where photographing has been requested by the user 501 operating the operation member 513 arranged in the virtual window 510, a case where photographing has been requested by operating the camera 100, or the like. In a case where it is determined that photographing has been requested, the process proceeds to step S812. In a case where it is determined that photographing has not been requested, the process proceeds to step S816.

In step S812, the control unit 311 receives the photographed image from the camera 100.

In step S813, the control unit 311 performs 3D rendering processing on the basis of the position and orientation of the camera 100 calculated in step S807. Here, the control unit 311 generates an image of the virtual object 512. Note that, at this time, the control unit 311 may perform 3D rendering in consideration of the lens optical information received from the camera 100 in step S804. As a result, a more natural virtual object image reflecting the imaging characteristics of the camera 100 can be generated.

In step S814, the control unit 311 generates a composite image by combining the photographed image received from the camera 100 in step S812 and the image of the virtual object 512 generated in step S813.

In step S815, the control unit 311 transmits the composite image generated in step S814 to the camera 100.

In step S816, the control unit 311 determines whether or not to end the live view display (display of the live view image). In a case where it is determined to end the live view display, the processing of this flowchart ends. In a case where it is determined not to end the live view display, the process proceeds to step S803.

Note that, in step S809, the control unit 311 combines the virtual object with the live view image to generate the LV composite image as illustrated on the screen 600 of FIG. 6C. However, instead of the processing of step S809, the control unit 311 may transmit the image of the virtual object after the 3D rendering processing (after conversion) to the camera 100. Then, when acquiring the image in which the live view image and the image of the virtual object after conversion are combined from the camera 100, the control unit 311 may generate the LV composite image by combining the image and the image obtained by imaging the real space from the viewpoint of the HMD 300.

According to the first embodiment, the virtual object is arranged only in the image viewed by the user among the two images corresponding to the real space. Therefore, the processing steps of the PC 310 can be reduced as compared with the case where the virtual object is arranged in both of the two images. In addition, since a lot of processing can be spent for rendering one virtual object, a higher-quality MR image can be generated. Therefore, according to the first embodiment, it is possible to generate, with a lower load, a high-quality image including a real space and a virtual object, which is an image for confirming what kind of photographing is possible for the user.

### Modification 1

In the first embodiment, when looking at the virtual window 510 (the region of the image obtained by imaging the space by the camera 100), the control unit 311 arranges the virtual object 512 in the virtual window 510. At this time, the control unit 311 does not arrange the virtual object 503 in the region of the image obtained by imaging the space according to the user's viewpoint. On the other hand, the control unit 311 does not arrange the virtual object 512 in the virtual window 510 when not looking at the virtual window 510 (the region of the image obtained by imaging the space by the camera 100). At this time, the control unit 311 arranges the virtual object 503 in the region of the image obtained by imaging the space according to the user's viewpoint.

However, if the load of the virtual object rendering or composite processing can be reduced as compared with the case of generating the screen 600 illustrated in FIG. 6A, an advantageous effect can be obtained as compared with the conventional technique. Therefore, for example, when looking at the virtual window 510, the control unit 311 arranges the virtual object 512 in the virtual window 510. At this time, the control unit 311 arranges a virtual object 503 having a resolution lower than that in a case of not looking at the virtual window 510, in a region of an image obtained by imaging the space according to the user's viewpoint. On the other hand, in a case of not looking at the virtual window 510, the control unit 311 arranges the virtual object 503 in the region of the image obtained by imaging the space according to the user's viewpoint. At this time, the control unit 311 arranges, in the virtual window 510, the virtual object 512 having a resolution lower than that in a case of looking at the virtual window 510. This can also reduce the load of the virtual object rendering and composite processing.

Note that not only a virtual object with reduced resolution but also a virtual object with arbitrarily reduced image quality (virtual object subjected to reduction in rendering accuracy, no coloring, and the like) may be used. That is, any method can be adopted as long as the load of the rendering or composite processing can be reduced as compared with the case of generating the screen 600 illustrated in FIG. 6A.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is equal to or smaller than B, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. For this reason, unless there is a contradiction, “A or more” may be read as “larger (higher; longer; more) than A”, and “A or less” may be read as “smaller (lower; shorter; less) than A". Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to generate a high-quality image including a real space and a virtual object with a lower load, the high-quality image being an image for confirming what kind of photographing is possible for a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) ^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216352, filed December 11, 2024, which is hereby incorporated by reference herein in its entirety.

What is claimed is:

1. An information processing device communicably connected to an imaging device, the information processing device comprising:
a processor; and
a memory storing a program which, when executed by the processor, causes the information processing device to:
execute first acquisition processing of acquiring a first image in which a space is imaged according to a viewpoint of a user;
execute second acquisition processing of acquiring a second image in which the space is imaged by the imaging device; and
execute control processing of generating a composite image obtained by combining a virtual object, the first image, and the second image, wherein
in the control processing,
in a first case where it is determined that the user is not looking at a region of the second image in the composite image, control is performed such that the virtual object is combined with a region of the first image in the composite image, and the virtual object is not combined with the region of the second image in the composite image, and
in a second case where it is determined that the user is looking at the region of the second image in the composite image, control is performed such that the virtual object is combined with the region of the second image in the composite image, and the virtual object is not combined with the region of the first image in the composite image.

2. The information processing device according to claim 1, wherein in the control processing, in the second case,
optical characteristic information including lens aberration information is acquired from the imaging device, and
the virtual object based on a position and orientation of the imaging device is converted on a basis of the optical characteristic information and then combined with the second image.

3. The information processing device according to claim 1, wherein in the control processing, in the second case,
the virtual object is converted on a basis of a position and orientation of the imaging device,
an image of the virtual object after conversion is transmitted to the imaging device, and
when a third image obtained by combining the second image and the image of the virtual object after conversion is acquired from the imaging device, the composite image is generated by combining the first image and the third image.

4. The information processing device according to claim 1, wherein in the control processing, in a case where it is determined that a predetermined region including the region of the second image is located in a line-of-sight direction of the user, it is determined that the user is looking at the region of the second image.

5. The information processing device according to claim 1, wherein in the control processing, in a case where it is determined that an occupancy rate of the second image in the composite image exceeds a predetermined threshold, it is determined that the user is looking at the region of the second image.

6. The information processing device according to claim 1, wherein in the control processing, in a case where it is determined that the user is operating an operation member corresponding to the second image, it is determined that the user is looking at the region of the second image.

7. An information processing device communicably connected to an imaging device, the information processing device comprising:
a processor; and
a memory storing a program which, when executed by the processor, causes the information processing device to:
execute first acquisition processing of acquiring a first image in which a space is imaged according to a viewpoint of a user;
execute second acquisition processing of acquiring a second image in which the space is imaged by the imaging device; and
execute control processing of generating a composite image obtained by combining a virtual object, the first image, and the second image, wherein
in the control processing,
the virtual object is combined with each of a region of the first image and a region of the second image in the composite image, and
in a first case where it is determined that the user is not looking at the region of the second image in the composite image, a quality of an image of the virtual object combined with the region of the second image is reduced as compared with a second case where it is determined that the user is looking at the region of the second image in the composite image, and
in the second case, a quality of the image of the virtual object combined with the region of the first image is reduced as compared with the first case.

8. A control method for an information processing device communicably connected to an imaging device, the control method comprising:
acquiring a first image in which a space is imaged according to a viewpoint of a user;
acquiring a second image in which the space is imaged by the imaging device; and
generating a composite image obtained by combining a virtual object, the first image, and the second image, wherein
in the generating,
in a first case where it is determined that the user is not looking at a region of the second image in the composite image, control is performed such that the virtual object is combined with a region of the first image in the composite image, and the virtual object is not combined with the region of the second image in the composite image, and
in a second case where it is determined that the user is looking at the region of the second image in the composite image, control is performed such that the virtual object is combined with the region of the second image in the composite image, and the virtual object is not combined with the region of the first image in the composite image.

9. A control method for an information processing device communicably connected to an imaging device, the control method comprising:
acquiring a first image in which a space is imaged according to a viewpoint of a user;
acquiring a second image in which the space is imaged by the imaging device; and
generating a composite image obtained by combining a virtual object, the first image, and the second image, wherein
in the generating,
the virtual object is combined with each of a region of the first image and a region of the second image in the composite image, and
in a first case where it is determined that the user is not looking at the region of the second image in the composite image, a quality of an image of the virtual object combined with the region of the second image is reduced as compared with a second case where it is determined that the user is looking at the region of the second image in the composite image, and
in the second case, a quality of the image of the virtual object combined with the region of the first image is reduced as compared with the first case.

10. A non-transitory computer readable medium that stores a program, wherein the program causes a computer to execute the control method according to claim 8.

11. A non-transitory computer readable medium that stores a program, wherein the program causes a computer to execute the control method according to claim 9.
